(19) United States
(12) Patent Application Publication
(10) Pub. No.: US 2005/0200129 A1
(43) Pub. Date: Sep. 15, 2005

(54) Aseptic flanged joint

(76) Inventor: Louis C. Bongiorno, Millington, NJ (US)

Correspondence Address: ERNEST D. BUFF;ERNEST D. BUFF AND ASSOCIATES, LLC., 231 SOMERVILLE ROAD, BEDMINSTER, NJ, 07921, US

(21) Appl. No.: 11/077,951

(22) Filed: Mar. 11, 2005

Related U.S. Application Data
(60) Provisional application No. 60/553,093, filed on Mar. 15, 2004.

(51) Int. Cl. F16L 35/00

(52) U.S. Cl. 285/364

(57) ABSTRACT

A flanged joint system connects two pipes disposed along a common axis. A flange having a mating surface with a circumferential groove terminates each pipe. A gasket assembly comprising an outer annular, substantially rigid retaining ring and an inner deformable annular sealing member is interposed between the mating surfaces of the flanges. The flanges are clamped together with their mating surfaces in axially aligned, facing relationship. The retaining ring limits the impingement of the flanges and prevents overcompression of the deformable material. The joint is reliable and durable, and permits aseptic processing conditions to be maintained. Servicing and gasket replacement are readily accomplished.

This application claims the benefit of U.S. Provisional Application No. 60/553,093, filed Mar. 15, 2004.

### BACKGROUND OF THE INVENTION

1. Field of the Invention

This invention relates to the joining of tubes or pipes; and more particularly, to an aseptic flanged joint between pipes employing a rigid retaining ring that surrounds a gasket and limits the deformation thereof.

2. Description of the Prior Art

Flanged joints are widely used to interconnect tubes or pipes conveying a variety of fluids, including gases, liquids, liquids also containing solid or semi-solid matter, or other fluid-like media. The tubes may be either pressurized or under vacuum. The joints connect extended sections of tubes, as well as joining tubes to fittings, couplers, valves, pumps, inspection ports, and other related devices. An ideal joint is easily assembled with minimal cost and labor, and is capable of operating reliably under any conditions reasonably anticipated during its service life. It is essential that the joint remain sealed to prevent leakage either into or out of the system in which the tube is used. The materials comprised in the joint must be chemically and thermally compatible under operating conditions with substances they will contact and the surfaces of the joint fittings. In many cases, it is further required that the joint be easily disassembled for repair and maintenance operations, including the cleaning and sanitizing of systems and replacement of gaskets or the like. Ideally, the presence of the joint does not introduce any protrusion or other interruption of the uniform surface inside the piping that would increase the flow resistance of the piping, e.g. by disrupting or impeding the smooth flow of fluid therethrough.

The requirements for joints, including flanged joints, used in process systems that convey food, beverage, pharmaceutical, personal care, or other like products intended for human or animal use through ingestion or external application are especially demanding. These systems must be maintained under strictly aseptic conditions. As used herein and in the subjoined claims with reference to a process system, the term “aseptic condition” is understood to mean a condition in which there is substantially no growth of unwanted or pathogenic organisms and substantially no buildup of debris or other medium in which such organisms are likely to reproduce or be trapped, agglomerated, concentrated, or otherwise situated in a manner that is likely to contaminate any substance passing through the system. The term “aseptic product” is to be understood as referring to any of the aforementioned products that ordinarily must be processed under aseptic conditions. Moreover, no materials can be used in aseptic joint systems that would introduce any harmful or objectionable substances into the process stream for the aforementioned aseptic products. Many piping and joint systems that might be acceptable for general chemical or industrial processing are not able to satisfy one or more of the stringent requirements associated with processing aseptic products. For example, some known joint systems have a configuration wherein recesses, crevasses, O-ring grooves, or the like result in dead spaces or stagnation regions in which there is little or no flow of the fluid being transported. As a result, accumulation of debris likely to give rise to the accumulation and reproduction of pathogens is a serious concern. Also, some known gasket materials may impart objectionable flavors or even toxic substances into food, beverages, or pharmaceuticals. Furthermore, the use of certain substances that come into contact with the process fluid may be offensive to adherents of certain religious traditions.

A variety of techniques are in widespread use for making interconnections. Flanged joints employing deformable gasket material that is interposed between the flanges and deformed by axial compression between the flanges are commonly used. Various materials have been used for such gaskets, such as elastomeric materials, impregnated fibrous materials, and soft metal sheets. One form of such joint and seal is depicted generally at 9 in FIG. 1. Joint 9 connects generally cylindrical tubes 12, 14, which are attached to flanges 16, 18 (also known as ferrules) by welding, as shown, or by various other known techniques. Flanges 16 and 18 adjoin in end-to-end relationship about a common center axis 19. The flanges are substantially identical and have mating faces generally perpendicular to axis 19. Opposite the mating face of each flange is a clamping face including tapered section 36. When flanges 6 and 8 are mated, respective sections 36 cooperate to form a generally frustoconical peripheral surface. The joint is secured using clamp 40 and sealed using O-ring gasket 17. The flanges used on each side of joint 9 are substantially identical in shape.

The mating face surface of flanges 16 and 18 has an inner portion 30 and an outer portion 34 that are generally co-planar, along with an intermediate circumferential groove or recess 32 that accommodates gasket 17, which is in the form of a synthetic rubber O-ring, i.e. a cylindrical gasket having the shape of a torus or donut. The O-ring is located and received in grooves 32. Normally flanges 16 and 18 both include a groove 32. However, joints are sometimes used in which a groove is provided in only one of the flanges, the other flange having a fully planar mating surface. Of course, the groove in such embodiments must be correspondingly deeper. In other instances, the gasket is a cylindrical O-ring with a rectangular cross-section (not shown) instead of the more commonly used circular cross-section.

Joint 9 is secured with a split-ring clamp 40, which is ordinarily composed of metal. A major portion of the inner circumferential surface of clamp 40 has a V-shape with tapered surface portions 42. These tapered surfaces encircle and securingly engage correspondingly tapered outer sections 36 of flanges 16 and 18. Clamp 40 is split into a plurality of arc-like segments. As further illustrated in the form depicted in FIG. 2, clamp 40 has two generally semicircular arc segments 50, 52, each subtending an angle slightly less than 180°. Segments 50 and 52 are both bifurcated at each of their ends. A rigid linkage 54 joins ends 51 and 53 of segments 50 and 52, respectively, and is disposed between the furcations. Retaining pins 55 pass through and are secured in holes in ends 51 and 53. Pins 55 also pass freely through holes in opposite ends of linkage 54 to create rotatable joints between the segments 50, 52 and linkage 54, allowing segments 50 and 52 to pivot about pin 55 within a common plane. The opposite ends of segments 50 and 52 have enlarged, furcated ends 58 and 59, respectively. A retaining pin 62 passes through and is secured in holes in end 59. Pin 62 also passes freely through the eye of threaded eyebolt 60, which is located between the furcations of end 59. To secure the clamp, the free end of eyebolt 60 is rotated about pin 62 and into the space between the furcations of end 58. A threaded nut 64 is tightened onto eyebolt 60 and against a flat surface of furcated end 58 to place clamp 40 in closed position, as shown in FIG. 2.

The tightening of nut 64 acts to reduce the effective circumference of clamp 40. The resulting wedging of frustoconically tapered inner clamp surface 42 over opposed, complementary frustoconical sections 36 of the two flanges imparts an axially directed force urging the flanges together. Proper design of joint 9 requires that the degree of tightening clamp 40 that brings corresponding surfaces 30 and 34 of flanges 16 and 18 into contact causes a requisite degree of compression of O-ring 17. Proper sealing is effected if O-ring 17 substantially fills grooves 32 of both flanges, with contact between O-ring 17 and grooves 32 on each side that extends around the full circumference of each flange.

However, in practice a number of problems occur in reliably effecting seals using joints of the type depicted by FIG. 1. Ideally, both the application of clamp 40 depicted in FIG. 1 and the full seating of O-ring 17 in respective facing grooves 32 provide the required lateral alignment of the opposed flanges. At best, O-ring 17 provides only minimal lateral alignment of respective grooves 32. It is frequently found that joints are made up with the flanges not fully coaxially aligned. As a result, the corresponding grooves 32 in the two flanges are not aligned and O-ring 17 often is not fully and properly seated in both grooves 32. In this circumstance, tightening of clamp 40 may compress at least part of O-ring 17 between surfaces 30 or 34. Damage to the O-ring is likely, especially in parts that traverse the edges between groove 32 and the adjacent planar surfaces 30 or 34. Premature failure of the O-ring to seal commonly results. Moreover, surfaces 30 and 34 may not properly seat in this situation, in many cases creating a recess between surfaces 30 into which process fluid present in tubes 12 and 14 can collect. In some cases such a recess communicates with portions of groove 32 not filled with O-ring 17, increasing the likelihood of untoward consequences, such as microbial activity as described in detail above. A joint system that more positively assures proper alignment and a durable, effective seal is thus highly sought.

Moreover, even if the flanges are accurately aligned and the O-ring seal properly disposed in its grooves, the joint system of FIGS. 1-2 is prone to certain difficulties. The axial impingement of the mating flanges after the clamp is secured is limited by metal-to-metal contact of the flange faces. In some cases, especially after wear and tear that attends repeated assembly and disassembly of the flanged joint, contact occurs in regions 34, leaving some space between facing inner surface regions 30. Frequently, such an area becomes a trap, with the deleterious consequences set forth above.

In many applications, O-ring 17 must be replaced periodically. In some industrial manufacturing processes, required system repairs or periodic preventive maintenance dictate that flanged joints be disassembled and reassembled frequently. Exposure to required processing temperatures or to corrosive or abrasive process fluids in some cases causes seal materials to erode. Some materials are embrittled over time by exposure to their process environment. Moreover, many seal materials exhibit creep or related mechanical phenomena or otherwise lose their elasticity and take a permanent “set.” Joints that are clamped together repeatedly despite poor alignment also are likely to result in wear or damage (e.g. scratching) to mating surfaces 30, 34, which may also compromise seal integrity. Cleaning and sanitary protocols demand regular service of joints and replacement of seals in still other instances. The actual cost of the O-ring and other elastomeric components typically is small in comparison with the labor costs for their replacement and the losses due to manufacturing downtime. However, the metal parts of the joint are generally far more expensive due to the precision machining and dimensional control needed. As a result, it is highly desired that metal parts be reusable.

Notwithstanding numerous improvements in the materials and configurations known for flanged joints, there remains a need in the art for a joint system that is inexpensive to construct and simple to maintain; yet provides reliable and robust service. It would be particularly desirable if the system could be serviced by workers that do not need extensive training or a high skill level. Significant additional value would be afforded by a joint system in which needed repairs could be accomplished expeditiously to minimize costly downtime for the system or process with which it is associated.

### SUMMARY OF THE INVENTION

The present invention provides a flanged joint system for aseptically connecting first and second pipes disposed along a common axis. A first flange terminates the first pipe and a second flange terminates the second pipe. Each of the flanges is generally circular and has a flange outside diameter and a mating surface with a circumferential flange groove therein. A gasket assembly is interposed between the flanges, the pipes being oriented such that the mating surfaces are substantially perpendicular to the common axis and in facing, parallel relationship. The gasket assembly comprises: (i) an outer annular, substantially rigid retaining ring having opposed axial surfaces that abut at least a portion of the flanges' mating surfaces; and (ii) an inner deformable annular sealing member having a retaining ring groove circumferentially extending about an outside periphery of the sealing member, an axially enlarged annular outer portion, and a radially inner annular portion having a rectangular cross-section and sealing surfaces on the axial sides of the rectangular portion. The retaining ring is removably engaged in the retaining ring groove and the gasket assembly is located by receipt of the annular outer portion in the circumferential flange grooves. The joint is secured by a clamp means, such as a split-ring clamp, that urges the flanges together axially. The compression of the deformable annular sealing member is restricted to a preselected extent, the compression being limited by abutment of the axial surfaces of the retaining ring with the mating surfaces of the flanges.

In another aspect, the invention provides a method for assembling a flanged joint connecting first and second pipes disposed along a common axis. The method comprises: (i) providing a first flange terminating the first pipe and a second flange terminating the second pipe; (ii) providing a gasket assembly; (iii) orienting the pipes such that the mating surfaces are substantially perpendicular to the common axis and in facing, parallel relationship; (iv) interposing the gasket assembly between the mating surfaces; and (v) clamping the flanges together axially. The gasket assembly comprises an outer annular, substantially rigid retaining ring and an inner deformable annular sealing member. The retaining ring is removably engaged in a retaining ring groove circumferentially extending about an outside periphery of the sealing member. The sealing member also has an axially enlarged annular outer portion and a radially inner annular portion having a rectangular cross-section and sealing surfaces on the opposed axial sides of the rectangular portion. The annular outer portion of the sealing member is received in the circumferential flange grooves. The clamping of the flanges axially compresses the deformable annular sealing member to a preselected extent, the compression being restricted by abutment of the respective axial surfaces of the retaining ring and the mating surfaces of the flanges.

The use of the outer retaining ring in the gasket assembly limits the axial impingement of the flanges, thereby insuring that a preselected, proper degree of compression of the deformable portion of the gasket assembly is achieved. Excessive tightening, which frequently causes undesirable extrusion and possible removal of deformable gasket material into the bore of the joint assembly, is effectively prevented. Misalignment or misplacement of the gasket assembly within the flange joint is likewise minimized.

The present flange joint system virtually eliminates the formation of traps in recesses of the joint in which process fluid can collect or stagnate, which frequently leads to the presence or growth of harmful microbes or other pathogenic organisms. The joint is easily assembled and disassembled to permit servicing, including replacement of the gasket assembly. The separability of the sealing member and the retaining ring of the gasket permits the former to be replaced and the latter, which is ordinarily more expensive to manufacture, to be reused. The joint is reliable and durable. The servicing can be carried out expeditiously by personnel who need not have a high level of skill, thereby lessening maintenance costs and manufacturing downtime.

### BRIEF DESCRIPTION OF THE DRAWINGS

The invention will be more fully understood and further advantages will become apparent when reference is had to the following detailed description of the various embodiments of the invention and the accompanying drawings, wherein like reference numerals denote similar elements throughout the several views, and in which:

FIG. 1 is a cross-sectional view depicting a prior art flanged joint connecting two pipes disposed along a common axis, with the cross section being taken along a common diametrical plane of the pipes;

FIG. 2 is a plan view showing in greater detail the clamp used to secure the flanges joined to form the sealed joint depicted by FIG. 1, the cross-section of the clamp seen in FIG. 1 having been taken at level I-I;

FIG. 3 is a cross-section view depicting a flanged joint system of the invention connecting two pipes disposed along a common axis, with the cross section being taken along a common diametrical plane of the pipes;

FIG. 4 is a cross-sectional view depicting another flanged joint system of the invention connecting two pipes, wherein the flanges are secured by C-clamps, with the cross section being taken along a common diametrical plane of the pipes;

FIG. 5 is a cross-sectional view depicting still another flanged joint system of the invention connecting two pipes, wherein the flanges are secured by bolts through the flanges, with the cross section being taken along a common diametrical plane of the pipes; and

FIG. 6 is an axial plan view of one of the flanges of FIG. 5, the view being taken as shown by VI-VI in FIG. 5.

### DETAILED DESCRIPTION OF THE PREFERRED EMBODIMENTS

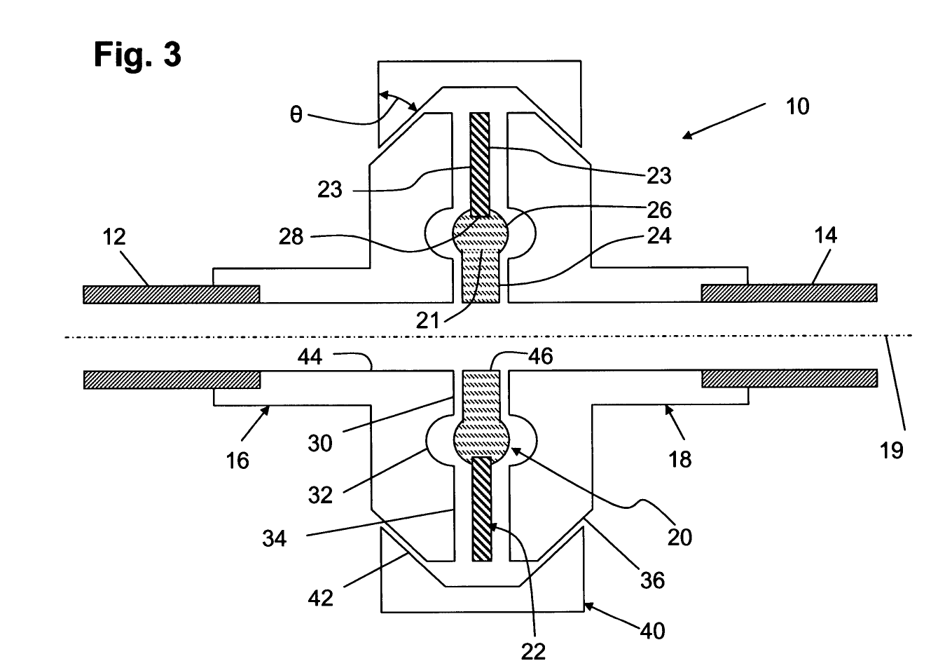

Referring to the drawings there is shown in FIG. 3 an embodiment of a flanged joint system of the invention. Joint 10 connects first and second, generally cylindrical tubes 12, 14, which are welded to first and second flanges 16, 18 (also known as ferrules). Alternatively, the tubes may be attached by any other suitable method, non-exclusively including brazing, soldering, threaded connection, or any other similar technique that provides a durable, leak-resistant connection. Flanges 16 and 18 adjoin in end-to-end relationship about a common center axis 19. The flanges are substantially identical and have mating face surfaces generally perpendicular to axis 19. Opposite the mating face of each flange is a clamping face including tapered section 36. When flanges 16 and 18 are juxtaposed, respective sections 36 cooperate to form a generally frustoconical peripheral surface. The joint is sealed using gasket assembly 20, which comprises a generally annular, rigid retaining ring 22 that is removably engaged with annular sealing member 21. Preferably sealing member 21 is resiliently deformable. Ring 22 is separably received at its radially inner periphery in circumferential groove 28 on the radially outward side of member 21. The outside diameter of ring 22 preferably is substantially equal to the outside diameter of flanges 16 and 18. The removability of member 21 from ring 22 allows assembly 20 to be renewed by substitution of a new member 21, with ring 22 being reusable. The flanges used on each side of joint 10 preferably have substantially identical form, rather than having complementary mating male and female forms used in certain other known types of joints. Accordingly, there is great flexibility in constructing and modifying a piping system in which the pipes and associated valves and fittings are assembled with joints configured as provided by the present invention.

The mating surfaces of flanges 16 and 18 have an annular inner portion 30, an outer portion 34, and an intermediate circumferential groove or recess 32. Surface portions 30 and 34 are generally flat and coplanar. Axially enlarged portion 26 of member 21 is located and received in groove 32. Preferably, groove 32 has a bottom shape that is approximately semicircular to engage complementarily shaped portion 26. However, other shapes for both groove 32 and portion 26 are optionally used. Member 21 further has a sealing portion 24 that is substantially rectangular in cross-section and radially inward of enlarged portion 26. The axial faces of rectangular portion 24 sealingly abut inner face portions 30 of flanges 16 and 18.

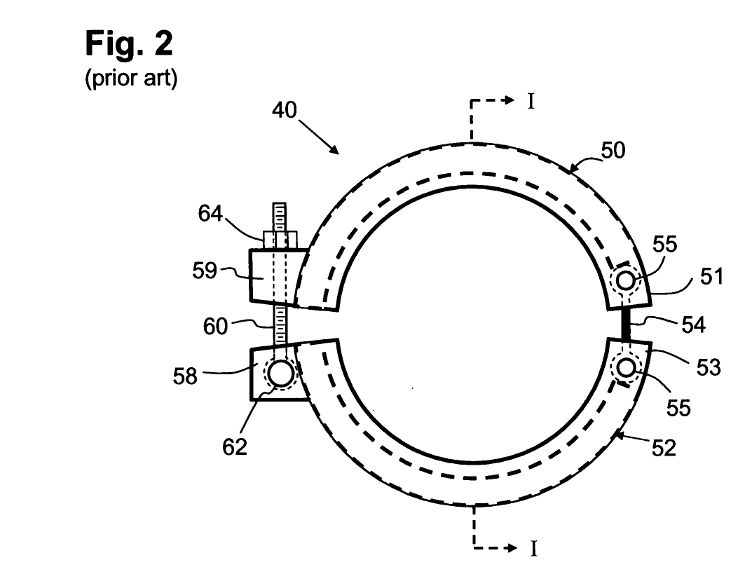

A clamp means, such as split-ring clamp 40 of the type depicted by FIG. 2, and having an inner circumferential surface with a V-shape and tapered surface portions 42, encircles and securingly engages correspondingly tapered, frustoconical outer sections 36 of flanges 16 and 18. The tapered surfaces of the clamp and flange are inclined at an angle θ as shown in FIG. 3, with 0 preferably ranging from about 15 to 25°. More preferably, θ is about 20°. Tightening the segments of clamp 40 imparts an axially directed force urging the flanges together. Flanged joints made using flanges having outside tapers, such as tapered surfaces 36 of flanges 16 and 18, in accordance with the present invention may be secured by clamps of a number of forms in addition to the type 40 depicted by FIG. 2. Any form of encircling clamp that produces an axially directed force applied to the tapered surface may be used. For example, linkage 54 and the nut and bolt fasteners 64, 60 may be replaced by other forms of lever engagement. The pivoting arrangement of linkage 54 may take alternate configurations. For example, linkage 54 and its attachments may be eliminated and ends 51 and 53 directly connected by a pivot pin. In still another form, linkage 54 and its attachments are replaced by a second nut and bolt fastener that is diametrically opposite and substantially similar to the first set used in the clamp of FIG. 2. Moreover, in the embodiment shown in FIGS. 2-3, both the outside tapered surfaces 36 of the flanges and the inside surface of clamp 40 have the shape of a frustoconical section of a right circular cone. In other embodiments of the invention, the clamping means comprises flanges and an encircling clamp either of which may have a taper that is other than the linear tapers shown in FIG. 3, such as curved tapers. Any such combination of shapes of the flanges and clamp interior that result in a clamping engagement that imparts a substantially uniform and axially directed force to the flanges may also be used.

The flanged joint provided herein may be used to join cylindrical pipes and tubes, e.g. those used in a process system. In addition, joints of the same form may be used to connect any combination of pipes, tubes, fittings, and other process equipment. The term “fittings” as used herein is to be understood as non-exclusively including adapters for connecting tubes of different sizes, ells for connecting pipes and tubes that are not collinearly directed, and fittings for connecting more than two pipes or tubes, such as tees and crosses. “Process equipment” as used herein non-exclusively comprises valves, filters, ports, reaction vessels, tanks, manifolds, pumps, and other components of a process system which are connected to place them in fluidic communication with other elements. As used herein and in the subjoined claims, the term “pipe” in relationship to a flanged joint is understood to include ordinary cylindrical pipe and tubing as well as any of the aforementioned fittings and process elements that are in fluidic communication with other elements through the joint. It is also to be understood that the axis of such fittings and process elements is the direction in which fluid enters or exits the element, which may or may not be a simple straight direction.

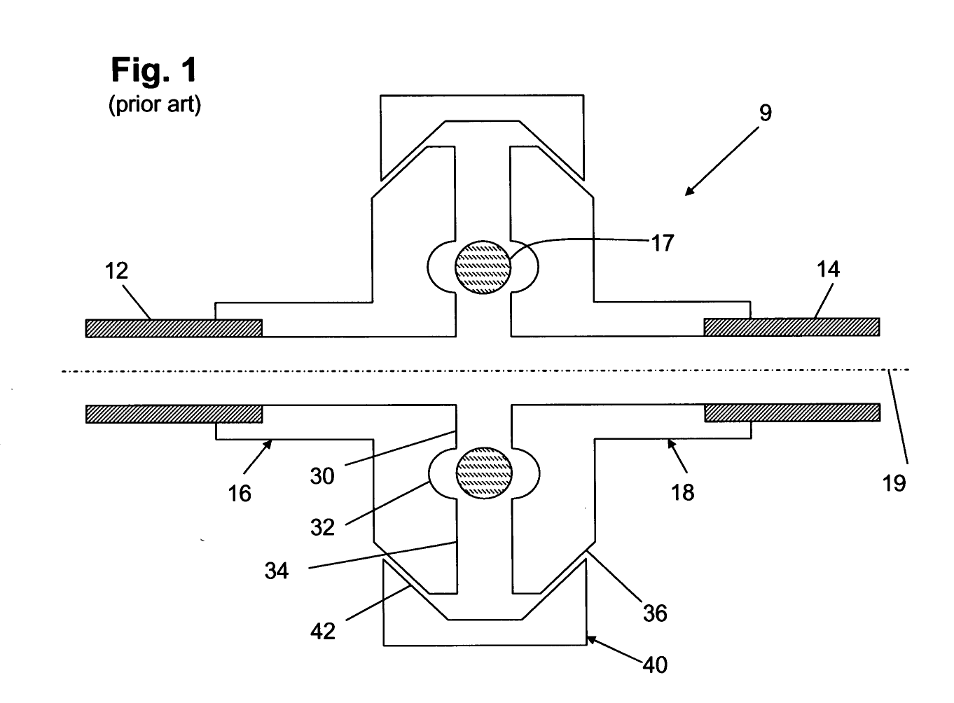

Many flanged joints used in existing process systems are easily modified to the configuration of the joint system of the present invention. In particular, joints using flanges having forms such as those of flanges 16 and 18 depicted in FIGS. 1 and 3 are commonly used. These joints may be retrofitted using suitably configured and dimensioned gasket assemblies of the invention. In one aspect, such a retrofit may be accomplished by suitable choice of the relative thicknesses of inner portion 24 of sealing member 21 and outer ring 22. In addition, the thickness of portion 26 of sealing member 21 is chosen to suitably fill circumferential grooves 32.

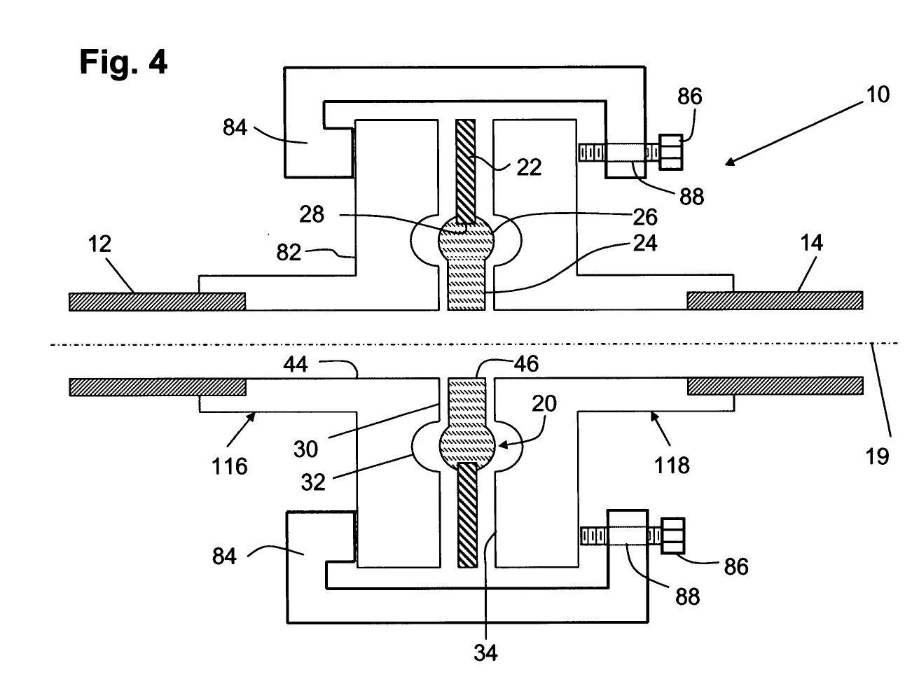

In another aspect of the invention depicted by FIG. 4, flanges 116 and 118 have outside faces 82 that are parallel to their respective mating surfaces 30, 34. Such flanges may be secured by clamps of a number of types, including the plurality of C-clamps 84 shown in FIG. 4. Advancement of a threaded bolt 86 through tapped hole 88 in each clamp tightens the clamp, thereby placing flanges 116, 118 in axial compression and effecting a seal by compressing sealing portion 24 of gasket assembly 20. The compression of gasket assembly 20 is again limited to a preselected extent by retaining ring 22, which limits the axial impingement of flanges 116, 118.

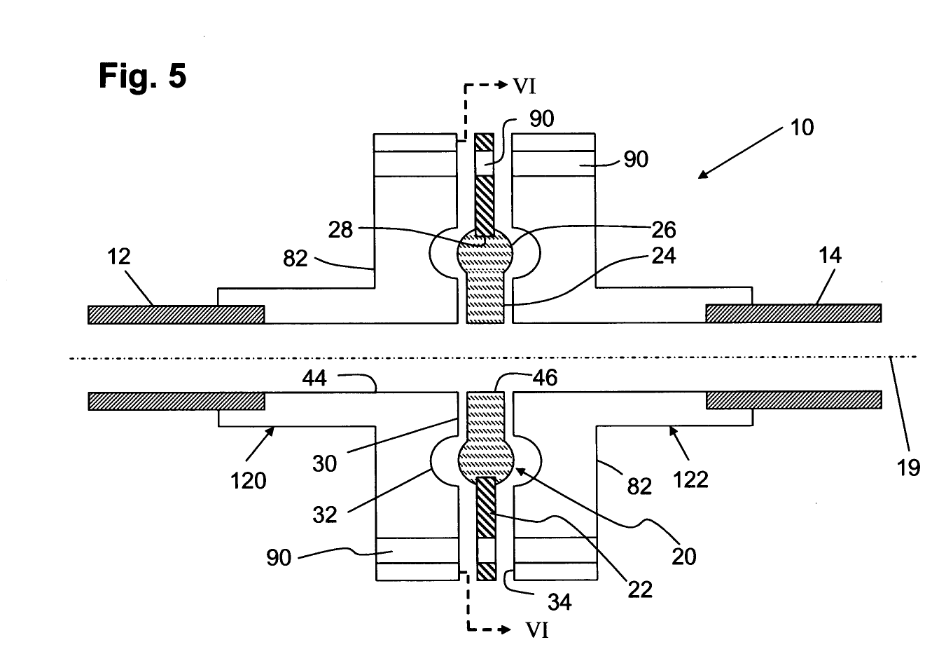

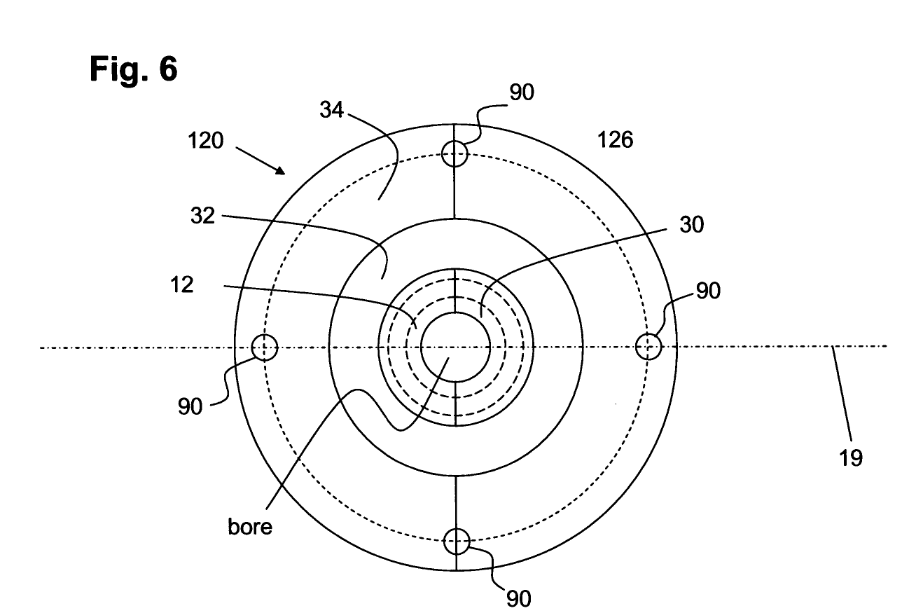

In still another aspect of the invention, depicted by FIG. 5, flanges 120, 122 are provided with outside clamping faces 82 that are parallel to their respective mating surfaces 30, 34. As best seen in FIG. 6, flanges 120, 122 and retaining ring 124 are provided with a plurality of holes 90 located on a bolt circle 126 that is centered on the common central axis of tubes 12, 14. Preferably the holes are equiangularly spaced about the bolt circle. In the embodiment shown in FIG. 6, four bolt holes 90 spaced at equal 90° intervals are shown, but fewer or more holes may be provided, so long as their number is sufficient to effect uniform compression of the flanges. Flanges 120, 122 are mated positively in alignment and secured by fasteners, such as threaded bolts (not shown) that pass through holes 90 in both flanges and intermediately through aligned holes in ring 22 and are engaged by threaded nuts (not shown). Tightening the bolts brings gasket assembly into compression to an extent limited by the abutment of surfaces 34 and ring 22. Alternatively, the holes in one of the flanges and ring 22 may be sized to clear a bolt of a requisite size, with the complementary holes in the other flange being threaded to accommodate the selected bolt.

At least two clamps or bolts are used to secure the flanges in embodiments such as those depicted in FIGS. 4-6. A larger number is ordinarily preferred, in particular a number of clamps or bolts that is sufficient to ensure that force is evenly applied around the circumference of the flanges. Flanges of larger diameter typically require a larger number of clamps or bolts to prevent uneven force that may, in some cases, cause the flange to bend or warp, thereby compromising the integrity of the seal.

In the various embodiments of the flanged joint of the invention, the axial approach of the flanges is positively limited by contact of mating surface portions 34 with the axially opposite sides 23 of retaining ring 22. The axial thickness of sealing portion 24 is selected to be slightly greater than that of ring 22, so that a requisite degree of compression of portion 24 is achieved when the flanges are engaged to the limit defined by retaining ring 22. Preferably, enlarged portion 26 is sized to substantially fill recess 32 when compressed. As a result, dead volume in which any process fluid inadvertently leaked from the flange bore could become trapped or stagnant is substantially eliminated. The absence of such dead space is especially important in systems used for aseptic processing of foodstuffs, beverages, pharmaceuticals, or the like, intended for human or animal consumption. Preferably, the inner diameter of sealing member 21 is selected such that the assembled flange joint system has a smooth inner bore through its entire axial length. That is to say, when sealing member 21 is in its compressed state after normal installation in joint 10, inner surface 46 of portion 21 and inner surface 44 of flanges 16 and 18 have substantially the same inside diameter and no gasket material intrudes into the bore. As a result, there is substantially no discontinuity at the transitions between flanges 16 and 18, and sealing member 21. In many prior art systems without the compression limit afforded by ring 22, overtightening and poor alignment frequently results in the extrusion of gasket material into the cylindrical bore of flanges in the joint region. A bore through the full joint with a smooth inner surface affords significant advantages. Flow of process fluid within the piping system is not impeded by unwanted turbulence. There are no projections that restrict draining of the piping system, even in horizontal runs. The configuration substantially eliminates the possibility that small pieces of extruded material, which are prone to becoming dislodged, would enter and contaminate the process stream. The smoothness is especially valuable in aseptic systems, since traps and dead zones are likely sites for harmful contamination and microbial activity. Furthermore, the retaining ring also provides protection against blowout of the sealing member under extreme overpressure conditions within the piping system.

A wide variety of materials are suitable for the components of the present joint system. In general, the materials must have mechanical and chemical properties that remain compatible with the conditions they are likely to encounter during their intended useful lifetime in a given process apparatus, with an acceptable margin of safety for process excursions and material variability. In particular, materials exposed to the process stream must be chemically stable, and the mechanical properties must be adequate for the joint to maintain its integrity during the joint lifetime.

The flanges are preferably composed of metal or metal alloys, including non-exclusively steel, copper, aluminum, brass, and nickel. Preferred alloys for the flanges include austenitic and ferritic stainless steels, Ni-base superalloys, monel, and inconel. Many of these alloys afford improved corrosion resistance and acceptable high temperature properties. Optionally, at least part of the flange mating surfaces or the flange bore are coated, plated, hardfaced, or otherwise beneficially treated with suitable substances to improve any of their properties. Ideally, the flanges are composed of alloy that is easily processed or machined as needed to provide the required configuration, but has sufficient hardness and strength to resist scratching, wear, or mechanical degradation during assembly and operation, and especially during servicing. The flanges must be amenable to attachment to other piping systems by the desired means, such as the aforementioned welding, brazing, or soldering. Most important, the flanges must be made of material that is chemically compatible with the process fluid conveyed therethrough and withstand normal operating temperatures and pressures with an adequate safety margin.

The retaining ring is preferably composed of metal, metal alloy, or hard plastic or rubber of sufficient strength and modulus to render it substantially rigid. More preferably, the ring is composed of the same material used to construct the flanges.

A wide range of materials are suitable for constructing the sealing member, which is preferably composed of deformable elastomeric, polymeric, composite or fibrous materials, or soft metal. Such materials include natural, synthetic, and silicone-based rubbers. Frequently used rubber materials include ethylene propylene (EPDM), ethylene acrylate, polychloroprene (NEOPRENE®), nitrile (Buna), fluorocarbon (FKM, VITON® and Kel-F), silicone, and fluorosilicone rubbers. Other polymeric materials are also used, such as PTFE (TEFLON®), CTFE, PFA, and PEEK. Composite materials such as polysteel, which includes stainless steel powder in a PTFE matrix, may be used, despite being less compliant. The sealing member must be sufficiently deformable to achieve a reliable seal. More preferably, the material is highly compliant and resiliently deformable and does not take a “set” as a result of creep or other mechanical degradation during extended storage or operation. Most preferably, the sealing member is an elastomer or polymer. Suitable sealing members preferably exhibit durometer ratings in the range of about 70 to 90 Shore A. Other desired characteristics of sealing materials include low cost, ease of fabrication, and lack of significant environmental concerns. It is further preferred that no other sealants be required, since many known sealants would contaminate the process stream or cause degradation of typical elastomers.

Having thus described the invention in rather full detail, it will be understood that such detail need not be strictly adhered to but that various changes and modifications may suggest themselves to one skilled in the art, all falling within the scope of the present invention as defined by the subjoined claims.

1. A method for assembling a flanged joint connecting first and second pipes disposed along a common axis, the method comprising:
a) providing a first flange terminating said first pipe and a second flange terminating said second pipe, each of said flanges being generally circular and having a flange outside diameter and a mating surface having a circumferential flange groove therein,
b) providing a gasket assembly comprising:
an outer annular, substantially rigid retaining ring; and
an inner deformable annular sealing member having a retaining ring groove circumferentially extending about an outside periphery of said sealing member, an axially enlarged annular outer portion, and a radially inner annular portion having a rectangular cross-section and sealing surfaces on opposed axial sides of said rectangular portion,
said retaining ring being removably engaged in said retaining ring groove and;
c) orienting said pipes such that said mating surfaces are substantially perpendicular to said common axis and in facing, parallel relationship;
d) interposing said gasket assembly between said mating surfaces, said annular outer portion being received in said circumferential flange grooves;
e) clamping said flanges together axially to compress said deformable annular sealing member to a preselected extent, the compression being restricted by abutment of said axial surfaces of said retaining ring with said mating surfaces of said flanges.

2. A method as recited by claim 1, wherein said flanges have tapered outer sections and said clamping comprises the use of a split-ring clamp having an inner circumferential surface with tapered surface portions adapted to encircle and securingly engage said tapered outer sections.

3. A flanged joint system connecting two pipes disposed along a common axis, comprising:
a) a first flange terminating said first pipe and a second flange terminating said second pipe, each of said flanges being generally circular and having a flange outside diameter and a mating surface having a circumferential flange groove therein, said pipes being oriented such that said mating surfaces are substantially perpendicular to said axis and in facing, parallel relationship;
b) a gasket assembly comprising:
an outer annular, substantially rigid retaining ring having opposed axial surfaces abutting at least a portion of said mating surfaces; and
an inner deformable annular sealing member having a retaining ring groove circumferentially extending about an outside periphery of said sealing member, an axially enlarged annular outer portion, and a radially inner annular portion having a rectangular cross-section and sealing surfaces on opposed axial sides of said rectangular portion,
said retaining ring being removably engaged in said retaining ring groove and said gasket assembly being located by receipt of said annular outer portion in said circumferential flange grooves;
c) a clamp means for urging said flanges together axially, whereby said deformable annular sealing member is compressed to a preselected extent, said compression being restricted by abutment of said axial surfaces of said retaining ring with said mating surfaces of said flanges.

4. A flanged joint system as recited by claim 3, wherein said axially enlarged annular outer portion is sized to substantially fill said circumferential flange grooves when said mating surfaces of said flanges are compressed in abutment with said axial surfaces of said retaining ring.

5. A flanged joint system as recited by claim 3, wherein said axially enlarged annular outer portion has a substantially circular cross-section.

6. A flanged joint system as recited by claim 3, wherein said inner annular sealing member is resiliently deformable.

7. A flanged joint system as recited by claim 3, wherein said inner annular sealing member is composed of an elastomer.

8. A flanged joint system as recited by claim 7, wherein said sealing member is composed of a material selected from the group consisting of PTFE, PFA, polysteel, Buna, EPDM, silicone, FKM, PEEK, and CTFE materials.

9. A flanged joint system as recited by claim 3, wherein said inner angular sealing member is composed of a composite material comprising a polymer.

10. A flanged joint system as recited by claim 3, wherein said retaining ring is composed of metal.

11. A flanged joint system as recited by claim 3, wherein said retaining ring is composed of a substantially rigid plastic.

12. A flanged joint system as recited by claim 3, wherein said clamp means comprises at least one clamp.

13. A flanged joint system as recited by claim 12, wherein said clamp means comprises a plurality of C-clamps.

14. A flanged joint system as recited by claim 12, wherein said flanges have tapered outer sections and said clamp means comprises a split-ring clamp having an inner circumferential surface with tapered surface portions that encircle and securingly engage said tapered outer sections.

15. In a flanged joint system connecting first and second pipes disposed along a common axis, wherein a first flange terminates said first pipe and a second flange terminates said second pipe, each of said flanges being generally circular and having a flange outside diameter and a mating surface having a circumferential flange groove therein, said pipes being oriented such that said mating surfaces are substantially perpendicular to said common axis and in facing, parallel relationship, and a clamp urges said flanges together axially, the improvement wherein a gasket assembly is interposed between said flanges, and the gasket assembly comprises:
an outer annular, substantially rigid retaining ring having opposed axial surfaces abutting at least a portion of said mating surfaces; and
an inner deformable annular sealing member having a retaining ring groove circumferentially extending about an outside periphery of said sealing member, an axially enlarged annular outer portion, and a radially inner annular portion having a rectangular cross-section and sealing surfaces on opposed axial sides of said rectangular portion,
said retaining ring being removably engaged in said retaining ring groove and said gasket assembly being located by receipt of said annular outer portion in said circumferential flange grooves; and
said deformable annular sealing member is adapted to be compressed to a preselected extent restricted by abutment of said axial surfaces of said retaining ring with said mating surfaces of said flanges.

16. For use in a flanged joint system connecting first and second pipes disposed along a common axis, wherein a flange terminates each of said pipes, each of said flanges being generally circular and having a flange outside diameter and a mating surface with a circumferential flange groove therein, said pipes are oriented such that said mating surfaces are substantially perpendicular to said common axis and in facing, parallel relationship, and a clamp urges said flanges together axially, a gasket assembly comprising:
a) an outer annular, substantially rigid retaining ring having opposed axial surfaces adapted to abut at least a portion of said mating surfaces; and
b) an inner deformable annular sealing member having a retaining ring groove circumferentially extending about the outside periphery of said sealing member, an axially enlarged annular outer portion, and a radially inner annular portion having a rectangular cross-section and sealing surfaces on the axial sides of said rectangular portion,
said retaining ring being removably engaged in said retaining ring groove and said gasket assembly being adapted to be located by receipt of said annular outer portion in said circumferential flange grooves; and
said deformable annular sealing member being adapted to be compressed to a preselected extent restricted by abutment of said axial surfaces of said retaining ring with said mating surfaces of said flanges.
